(19) United States
(12) Patent Application Publication
(10) Pub. No.: US 2015/0218022 A1
(43) Pub. Date: Aug. 6, 2015

(54) Liquid CIO2

(71) Applicant: Chemtreat, Inc., Glen Allen, VA (US)

(72) Inventor: Andrew Doak, Richmond, VA (US)

(21) Appl. No.: 14/169,509

(22) Filed: Jan. 31, 2014

(51) Int. Cl. C02F 1/76; C02F 1/52; C02F 1/24

(52) U.S. Cl. CPC C02F 1/76; C02F 1/24; C02F 1/52; C02F 2101/30

(57) ABSTRACT

Disclosed are methods of reducing the chemical oxygen demand (COD) of waste water streams by treating the waste water streams with a concentration of chlorine dioxide generated using a 3-Chemical Method involving sodium chlorite, sodium hypochlorite and an acid. The chlorine dioxide treatment will typically be configured to remove at least 25% of the initial organic content of the waste water stream and may be combined with other water treatment techniques including, for example, dissolved air flotation (DAF), to achieve improved organic removal rates.

### BACKGROUND OF THE INVENTION

Many manufacturing operations can result in periodic accidental and/or anticipated discharges of organic or organic-modified liquids including, for example, hydraulic fluid(s), heat transfer fluids and quenching fluids. Steel and other metals may, for example, be manufactured using a continuous casting method in which molten metal is cast directly into thin strips, plates or other shapes in a casting machine. A typical arrangement includes a first casting roll mounted in fixed journals with a second casting roll being mounted on supports that can be moved relative to the first casting roll to accommodate and/or control fluctuations in the separation between the casting rolls and thereby control the casting thickness. The biasing force used for moving the second casting roll may be applied by a number of structures including, for example, a number of hydraulic cylinder units activated by and subject to releases of hydraulic fluid. Similarly, organic or organic-modified liquids can be used for cooling molds or other equipment and/or quenching hot metal issuing from other machines.

From a hydraulics perspective, many industrial machines are designed for operating with fire resistant hydraulic fluids, particularly water glycol (HFC) type hydraulic fluids. While water is an important part of such fluids, its presence can also create performance issues for the fluid. Water, for example, does not exhibit the lubricating film strength of mineral oil or various synthetic lubricating base stocks and thereby tends to limit the maximum operating pressure of the hydraulic system.

The high water solubility of water glycol fluid(s) can present a range of difficulties in an industrial setting including, for example, establishing adequate control of waste water discharges from industrial plants and facilities. Local municipalities, as well as state and federal agencies, may monitor water leaving an industrial site for contaminants including, for example, phenol content, FOG (fats, oils and grease), heavy metals and BOD (biological oxygen demand) and COD (chemical oxygen demand). As noted above, water glycol fluids are used widely throughout various industrial and hydraulic operations and tend to be applied, under high pressures, for actuating various components or for circulating through operating equipment for controlling operating temperature. As a result, leaks or other inadvertent discharges of water glycols during industrial operations are not uncommon.

Water glycol fluids that find their way into a waste water stream are typically not removed during standard waste treatment methods and tend to contribute substantially to increased BOD and COD levels in the effluent stream. As a result, many industrial operations are faced with treatment surcharges from their local waste water treatment facilities.

As a result, industrial operations have implemented a number of methods for suppressing the impact of inadvertent glycol discharges. Oxidation of ethylene glycol in aqueous solutions with a solution of hydrogen peroxide and an iron catalyst and subsequent UV irradiation. This method reduced the COD by converting ethylene glycol to oxalic and formic acids.

Two other methods for the substantially complete (>99%) destruction of ethylene glycol in waste water include ultraviolet (UV) light-catalyzed oxidation and supercritical oxidation. In the UV light-catalyzed oxidation method, for example, an ethylene glycol-containing waste water in the presence of 10% hydrogen peroxide is oxidized by UV irradiation (200-250 nm) with light from a mercury lamp. The UV/hydrogen peroxide undergoes photochemical decomposition to produce OH radicals that are strong oxidants capable of oxidizing most organic compounds stepwise to complete mineralization (e.g., carbon dioxide and water). In the supercritical water oxidation method, the waste water is subjected to oxidation at >550° C. and 4,000 psi pressure with a residence time of <30 seconds.

Chlorine dioxide has been identified as a useful biocide because of its combination of properties including, for example, its potency, rapid oxidation, general lack of pH sensitivity, efficacy and selectivity and has been found to be effective even at relatively low dosages. For example, maintaining a continuous free residual of just 0.1-0.5 mg/l of ClO₂ in a water supply has been shown to be effective in controlling a wide range of harmful bacteria and problematic microbes. Chlorine dioxide is also fast-acting, allowing chlorine dioxide solutions to disinfect and sanitize surfaces more quickly. Chlorine dioxide remains an effective biocide over a broad pH range of, for example, pH 4 to 10. Because chlorine dioxide is readily soluble in water without forming ionic species, it is able to permeate and penetrate biofilms, which can be relatively resistant to other disinfectants and biocides.

When chlorine dosing systems are used for purifying drinking water or any other aqueous stream that contains natural organic compounds such as humic and fulvic acids, the chlorine treatment tends to produce halogenated disinfection by-products such as tri-halo-methanes (THMs). Drinking water containing such DBPs has been shown to increase the risk of cancer. Using chlorine dioxide rather than chlorine, however, utilizes a different reaction to achieve oxidation rather than halogenation of the organic species, thereby suppressing the formation of the problematic halogenated DBPs.

While chlorine dioxide is an extremely powerful oxidant, it also exhibits a lower reduction potential than most other commonly used oxidizing biocides and disinfectants. This lower redox potential reflects the utility of chlorine dioxide for killing the microbes without reacting with other contaminants, often resulting in much lower dosage rates to achieve suitable control, thereby reducing the overall cost of the treatment. As a result, chlorine dioxide is often used in drinking water purification and for water and production equipment used in food and beverage production, particularly meat production operations.

Chlorine dioxide can be generated using various methods, with more modern technologies tending to utilize methanol or hydrogen peroxide for providing efficient reactions and suppressing the co-generation of elemental chlorine. The overall reaction can be written according to the general equation [1]:

Chlorate+Acid+reducing agent→Chlorine Dioxide+By-products [1]

The reaction of sodium chlorate with hydrochloric acid in a single reactor is generally thought to proceed via the following reaction pathway as illustrated in reactions [2]-[4]:

HClO₃+HCl→HClO₂+HOCl; [2]

HCLO₃+HClO₂→2ClO₂+Cl₂+2H₂O; and [3]

HOCl+HCl→Cl₂+H₂O. [4]

The commercially more important production route uses methanol as the reducing agent and sulfuric acid for the acidity. Advantages associated with avoiding use of additional chlorine-containing reactants include suppressing or eliminating the formation of elemental chlorine and the generation of sodium sulfate as a valuable side-product. These methanol-based processes have provided high efficiency and may be practiced with good safety performance.

A growing proportion of the chlorine dioxide manufactured for water treatment purposes and other small-scale applications has been made using chlorate, hydrogen peroxide and sulfuric acid. One method of generating chlorine dioxide intended for water treatment or disinfection treatment is using a sodium chlorite or sodium chlorite—hypochlorite method as illustrated in reactions [5] and [6], also referred to herein as the “3-Chemical Method” of chlorine dioxide generation method:

2NaClO₂+2HCl+NaOCl→2ClO₂+3NaCl+H₂O; [5]

2NaClO₂+H₂SO₄+NaOCl→2ClO₂+Na₂SO₄+H₂O; [6]

or the sodium chlorite-hydrochloric acid method illustrated in reaction [7]:

5NaClO₂+4HCl→5NaCl+4ClO₂+2H₂O. [7]

Each of these sodium chlorite chemistries are capable of producing chlorine dioxide with high chlorite conversion yield. The chlorite-HCl method, however, typically requires 25% more chlorite to produce an equivalent amount of chlorine dioxide.

While generally impractical for meeting real time industrial demand volumes, very pure chlorine dioxide may also be produced by electrolyzing a chlorite solution according to reaction [8]:

2NaClO₂+2H₂O→2ClO₂+2NaOH+H₂ [8]

High purity chlorine dioxide gas (7.7% in air or nitrogen) can also be produced by the Gas:Solid method, which reacts dilute chlorine gas with solid sodium chlorite according to reaction [9].

2NaClO₂+Cl₂→2ClO₂+2NaCl. [9]

Another method used for generating chlorine dioxide is the following reaction [10]:

NaClO₃+½H₂O₂+½H₂SO₄→ClO₂+½Na₂SO₄+½O₂+H₂O. [10]

### BRIEF SUMMARY OF THE INVENTION

The disclosed methods are useful for reducing chemical oxygen demand (COD) in waste water streams without producing unwanted chlorinated reaction byproducts. The methods include establishing a chlorine dioxide treatment concentration in a waste water stream, using chlorine dioxide that is generated in a solution of sodium chlorite, sodium hypochlorite and an acid (referred to herein as the “3-Chemical Method” or “3CM” for brevity). The treatment concentration may be selected to oxidize at least 25%, preferably 50% and, more preferably, at least 75% of the initial organic content over a treatment period.

Although the sodium chlorite and sodium hypochlorite are preferably used in a mole ratio of 2:1 for generating the chlorine dioxide, variations of this ratio may still provide acceptable chlorite conversion. The acid used in generating the chlorine dioxide will be hydrochloric acid, sulfuric acid or a mixtures thereof, and will preferably be supplied at a rate sufficient to establish a mole ratio of 2:1:1 to 2:1:2 between the sodium chlorite, sodium hypochlorite and acid reactants.

As will be appreciated, the treatment concentration of chlorine dioxide will depend on a number of factors including, for example, the organic content of the waste stream, the nature of the organic materials contributing to the organic content, the range of variation in the organic content over time, the treatment period over which the chlorine dioxide will be applied to the organic content and the target concentration for the treated waste water stream. Those of ordinary skill in the art, guided by the present disclosure, will be readily able to adapt the basic treatment methods to a wide range of specific applications without undue experimentation.

Although low levels of chlorine dioxide, e.g., 1, 2 and/or 3-5 ppm levels, may be sufficient in some applications, particularly those in which the COD levels are relatively low and under good control, it is anticipated that most industrial applications will need to utilize higher treatment concentrations, particularly in those instances in which a spill or other release of an organic contaminant such as ethylene glycol must be addressed. In such instances, it is anticipated that treatment concentrations of, for example, 10 ppm, 25 ppm, 50 ppm, 100 ppm, 200 ppm or perhaps even higher treatment concentrations may be necessary during at least some period of time, particularly when addressing a significant spill or pulse of organic contamination that significantly increases the organic content over a short period of time.

In those instances in which there is some low level background organic content contamination, the methods may be modified to include a baseline concentration or maintenance level of chlorine dioxide that is then increased to a higher treatment level as needed to respond to increased levels of organic contamination. In most instances, this baseline concentration of chlorine dioxide may represent a relatively low percentage of the treatment concentration, e.g., 5%, 10%, 25% or even up to 50% of the treatment level, depending on the relative magnitudes of the background organic levels and the periodic increases in the organic levels associated with leaks or other irregular discharges.

The efficacy of chlorine dioxide, particularly when provided at treatment concentrations tailored to the level of organic contamination present in the waste water stream, can produce sufficient reduction in the COD over a relatively short treatment period, particularly when compared with conventional methods utilizing hydrogen peroxide or other biocide. Accordingly, it is expected that treatment periods of, for example, 15 minutes, 30 minutes, 1 hour, or up to 4 hours, may be achieved with the present methods while still providing the desired level of COD reduction.

The chlorine dioxide COD reduction treatments may be combined with other unit operations for reducing contaminants in the waste water stream including, for example, coagulation, flocculation, sedimentation, dissolved air flotation, filtration and/or hydrocyclonic separation. Depending on the particular process(es) utilized, the chlorine dioxide can be introduced into the waste water stream before or after the supplemental process. For example, it has been found that introducing just 2 ppm of chlorine dioxide before the waste water stream entered a dissolved air flotation (DAF) module improved the efficiency of the DAF by as much as 30% compared with the standard process. The presence of the chlorine dioxide in such processes would also allow for the reduction or elimination of other biocides, such as hydrogen peroxide, that are added in conventional processes for controlling microbial growth within the system(s).

As will be appreciated, particularly in those instances in which the organic contaminant level of a waste water stream is highly variable, monitoring the incoming COD allows for the application of an appropriate concentration of chlorine dioxide. Similarly, monitoring the COD of the treated waste water stream confirms the efficacy of the treatment concentration and allows for appropriate adjustment of the chlorine dioxide feed rate in order to obtain and/or maintain the desired percentage reduction based on the incoming COD and/or ensure that the outlet COD concentration does not exceed a predetermined target value. Methods according to the invention may also provide for monitoring the treated waste water stream for the presence of halogenated disinfection by-products that would suggest the presence of chlorine in the waste water stream and trigger appropriate corrective action.

Given the variety of systems to which the disclosed methods may be applied, the chlorine dioxide treatments should be incorporated as part of an overall protocol that is established for identifying and controlling the chemical oxygen demand of a target aqueous stream. The protocol should, in particular, provide guidance to operators and other plant personnel for the identification of and response to excursions from the base level of chemical oxygen demand. These excursions may be the result of spills, leaks or other variable discharges of organic materials, such as organic alcohols including, for example, ethylene glycol, of sufficient volume to produce rapid and substantial increases in the chemical oxygen demand. The protocol will include guidance for the generation and application of a sufficient quantity of chlorine dioxide via the 3CM over a treatment period to achieve a desired reduction in the COD of the treated stream.

### BRIEF DESCRIPTION OF THE DRAWINGS

Example embodiments of apparatus that could be used for practicing the invention are described more fully below with reference to the attached drawings in which:

FIG. 1 illustrates the results of a first series of experiments investigating the reduction of COD, primarily attributable to glycol and glycol-based fluids, using chlorine dioxide;

FIG. 2 illustrates the results of a second series of experiments investigating the reduction of COD, primarily attributable to glycol and glycol-based fluids, using chlorine dioxide;

FIG. 3 illustrates the results of a third series of experiments investigating the reduction of higher base levels of COD, again primarily attributable to glycol and glycol-based fluids, using chlorine dioxide;

FIG. 4 illustrates the results of a fourth series of experiments investigating the reduction of higher base levels of COD, again primarily attributable to glycol and glycol-based fluids, using substantially identical concentrations of chlorine dioxide generated using difference generation chemistries; and

FIG. 5 illustrates the results of a fifth series of experiments investigating the reduction of higher base levels of COD, again primarily attributable to glycol and glycol-based fluids, using substantially identical concentrations of chlorine dioxide generated using difference generation chemistries.

It should be noted that these figures are intended to illustrate the general characteristics of methods and apparatus with reference to certain example embodiments of the invention and thereby supplement the detailed written description provided below.

### DETAILED DESCRIPTION OF THE INVENTION

As noted above, water glycol leaks and spills that reach waste water stream can cause dramatic increases in COD. Conventional treatments utilize hydrogen peroxide for reducing COD in a process during which hydrogen peroxide is fed into the system over an extended period of time of, for example, 8-12 hours. Applicants performed a series of tests over the course of several weeks in order to evaluate chlorine dioxide as a viable alternative to hydrogen peroxide.

Multiple rounds of tests were run over several weeks examining waste water samples drawn from different plants. Unexpectedly, the results suggested that the manner in which the chlorine dioxide was generated affected its performance at similar concentrations. In particular, it was discovered that chlorine dioxide generated using a 3CM reaction, for example using a 2:1 mole ratio of sodium chlorite to sodium hypochlorite in combination with hydrochloric acid, sulfuric acid, or combination thereof, as illustrated in reactions [5] and [6], was significantly more effective at reducing COD than similar concentrations of chlorine dioxide generated using other conventional methods.

2NaClO₂+2HCl+NaOCl→2ClO₂+3NaCl+H₂O; [5]

2NaClO₂+H₂SO₄+NaOCl→2ClO₂+Na₂SO₄+H₂O; [6]

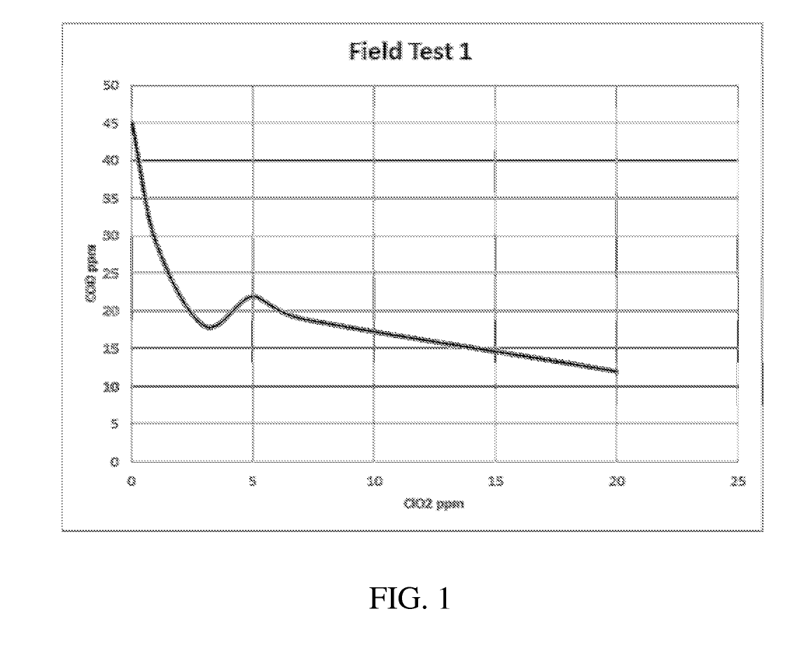

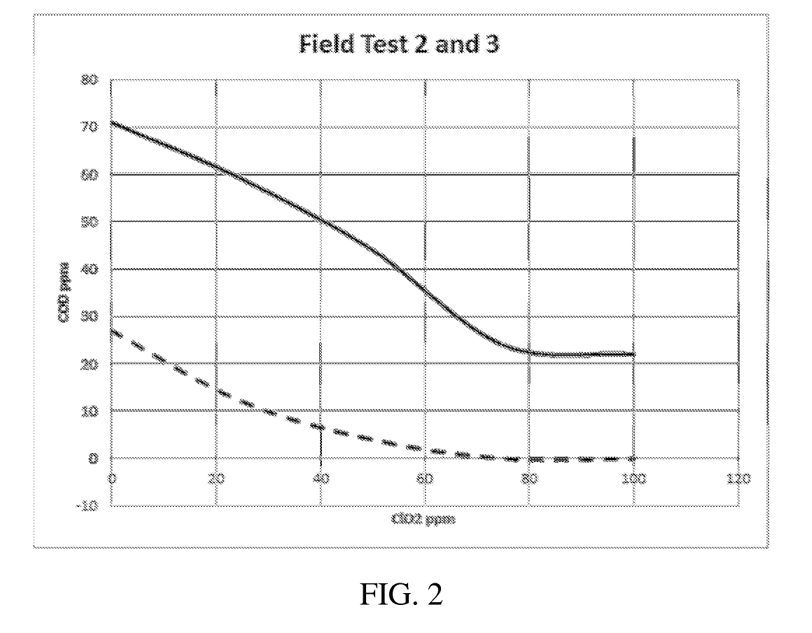

A first series of tests utilized caster mill water that included glycol and reflected a baseline chemical oxygen demand (COD). From a COD baseline of 45 ppm, treatment dosages of less than 10 ppm, achieved only some minor reduction in COD while a treatment concentration of 20 ppm achieved more than 70% COD Reduction. Another series of tests was run using samples with a baseline COD concentration of 71 ppm. In light of the increased concentration, the chlorine dioxide was also run at higher concentrations and was able to achieve COD reductions of at least about 60%. A third series of tests utilized caster mill water that again included glycol and reflected a baseline chemical oxygen demand (COD). From a COD baseline of 27 ppm, treatment dosages of 50 ppm, achieved an 85% reduction in COD with a 99+% reduction being achieved at 75 ppm. These results of these preliminary experiments are illustrated in FIGS. 1 and 2.

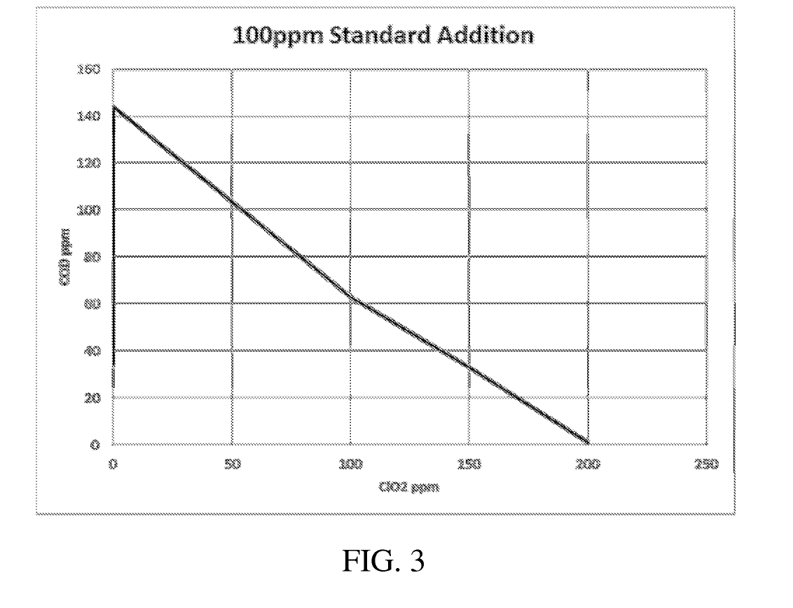

As will be appreciated, the volume of the spill(s) or other system glycol losses and the volume of the aqueous system into which they flow will determine the resulting increase in the system glycol concentration. In an evaluated system for example, a 50 gallon (190 liters) glycol spill produced a glycol concentration increase of about 100 ppm. In response to the spill, the system COD was effectively quadrupled, increasing from a 27 ppm baseline reading to 130 ppm. These higher COD values also increased the chlorine dioxide treatment demand, whereby treatment with 100 ppm chlorine dioxide was only able to achieve about a 50% reduction in the COD. Increasing the chlorine dioxide concentration to 200 ppm was able to achieve a much greater COD reduction. These results are illustrated below in FIG. 3.

Additional lab testing has confirmed the performance discussed above across samples obtained from different mills. Additional testing also examined the correlation between the manner in which chlorine is generated or otherwise introduced into the system and the efficacy of the solution for reducing COD. Results suggest that chlorine dioxide generated at the time of use by one or both of the 3CMs, as shown in reactions [5] and [6] above, is more effective at reducing COD than chlorine dioxide generated using other methods.

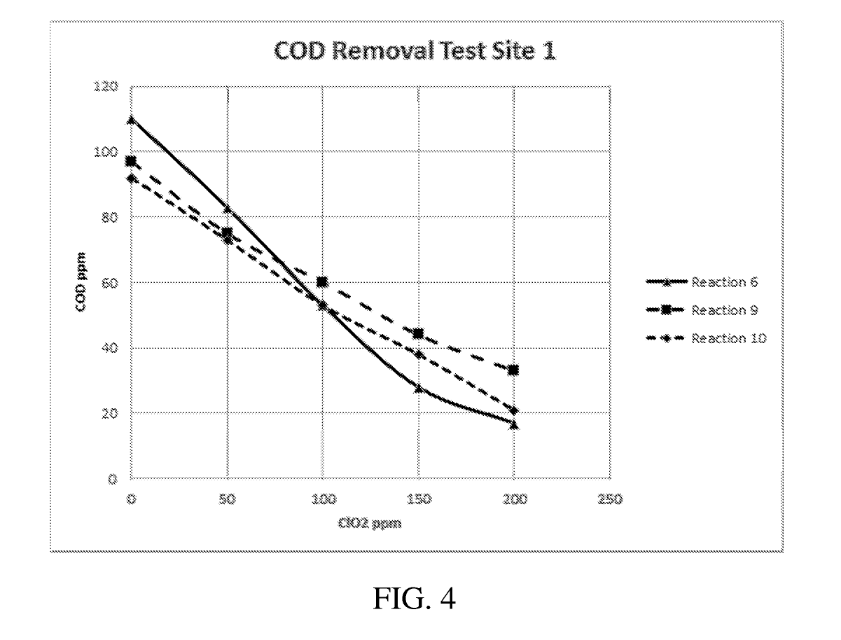

Additional lab testing also looked at the performance of industrial glycol samples when treated with similar concentrations of chlorine dioxide applied using different methods. For example, during this test, the treatment achieved a COD reduction of >40% at 150 ppm and a 55% reduction of COD reduction at 200 ppm. These results are illustrated in FIG. 4.

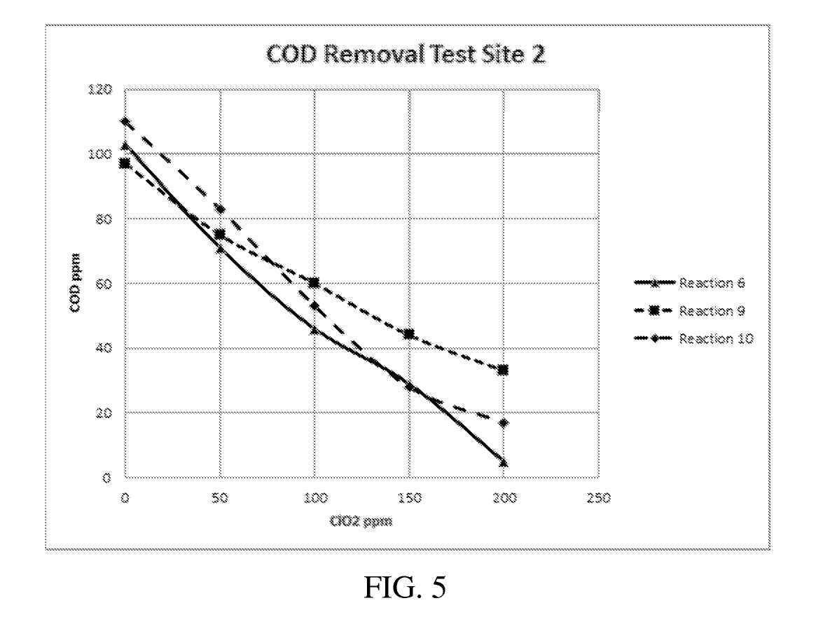

Similar testing was conducted on samples obtained from a second industrial source and chlorine dioxide produced using 1) the preferred 3CM, 2) a combination of sodium chlorate and peroxide, or 3) a previously-prepared ClO₂ concentrate having a base chlorine dioxide concentration of about 3000 ppm. Again the 3CM generated chlorine dioxide was more effective, with COD reductions of more than 70% at 150 ppm and more than 95% at 200 ppm. These results are illustrated below in FIG. 5. Again the chlorine dioxide from both a concentrated ClO₂ solution and that generated from the sodium chlorate and peroxide reaction [10], as illustrated below in FIG. 5, performed somewhat less well than ClO₂ generated with the 3CM with COD reductions of more than 55% at 150 ppm and more than 65% at 200 ppm.

Additional testing was conducted on other waste water samples. Again, the 3CM generated chlorine dioxide was more effective in reducing COD, achieving reductions of more than 93% at 100 ppm (from a baseline of 66 ppm) and more than 86% at 100 ppm (against baseline of 100 ppm). Although able to reduce COD, chlorine dioxide applied to the system by diluting a concentrate performed less well than that generated with the 3CM with COD reductions of approximately 78% at 100 ppm from a 66 ppm baseline and 53% at 100 ppm.

Additional testing data comparing ClO₂ generated using the 3CM and corresponding ClO₂ concentrations applied using a previously prepared concentrate reflected this variation in efficacy as shown in Table 1. Glycol challenge testing was also conducted using ClO₂ generated using the 3CM, from ClO₂ concentrate, and using a sodium chlorate/peroxide method and, as illustrated below in Table 2, again demonstrated greater efficacy when the ClO₂ was generated using the 3CM.

TABLE 1

| ClO₂ Generation Means | 3-Chemical | Concentrate | Baseline |
|---|---|---|---|
| COD Reduction at 100 ppm | 93% | 78% | 66 ppm |
| COD Reduction at 100 ppm | 86% | 53% | 90 ppm |

TABLE 2

| | | | Sodium |
|---|---|---|---|
| ClO₂ Generation Means | 3-Chemical | Concentrate | chlorate/Peroxide |
| COD Reduction at | 70% | 55% | 56% |
| 150 ppm | | | |
| COD Reduction at | 95% | 65% | 74% |
| 200 ppm | | | |

The disclosed methods, therefore, can be used to provide improved COD control in a number of waste water streams generated in industrial applications that are periodically or randomly subject to contamination by organic materials including, for example, hydraulic fluids, antifreeze compounds. The waste water streams may be monitored for the expected contamination that, when detected, triggers the addition of a quantity of ClO₂ sufficient to reduce the COD by at least 25%, preferably by at least 75% and more preferably by at least 90%. The efficacy of the treatment can be monitored and the amount of ClO₂ reduced or eliminated as the contaminant surge declines. The noted improvement in the COD reduction achieved by methods according to the invention provided additional benefits including, for example, reducing the amount of bleach, hydrogen peroxide and bromide/bromine used in conjunction with a range of conventional waste water treatment methods. In most instances, the pH range of the treated solutions will be maintained within a slightly alkaline range, e.g., 8.0 to 9.0, although the disclosed methods are expected to provide satisfactory results over a broader pH range of, for example, 7.0 to 10.0.

The use of ClO₂ according to the methods disclosed herein will tend to reduce the treatment time and/or the quantity of treatment chemicals necessary to achieve a desired degree of reduction in COD when compared with conventional treatment methods. In some instances, the presence of ClO₂, particularly 3CM ClO₂, produces an oxidizing environment that can also enhance coagulation processes for removing transition metals, such as iron, from the treated waste water stream.

Similarly, in those systems that typically exhibit some baseline level of organic contaminants, a suitable baseline level of ClO₂ may be maintained with increased levels of contamination being addressed in the manner detailed above, after which the ClO₂ feed rates may be reduced to return the system to the baseline levels.

The chlorine dioxide treatment methods according to the invention can be used in combination with Dissolved Air Flotation (DAF) treatment processes for clarifying waste water streams by removing suspended matter such as oil or solids. The removal is achieved by dissolving air in the waste water under pressure and then reducing the pressure to, for example, atmospheric pressure in a flotation tank or basin so that the dissolved air is released throughout the treated volume of waste water. The released air forms tiny bubbles which tend to adhere to the surface of any suspended matter, effectively reducing the effective density of the suspended matter so that it floats to the surface where it can then be removed by, for example, a skimming device. DAF is very widely used in treating the industrial wastewater effluents from oil refineries, petrochemical and chemical plants, natural gas processing plants, paper mills, general water treatment and similar industrial facilities.

The addition of even relatively low treatment levels (˜2 ppm) of chlorine dioxide into the waste water via the preferred 3CM substantially improves the COD reduction that can be achieved through DAF and does so to an extent greater than the use of chlorine dioxide generated from concentrate or from sodium chlorate and peroxide. Initial testing of a DAF process with addition of just 2 ppm chlorine dioxide (generated via the 3CM) showed improved COD reduction on the order of 15-30%.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the disclosure.

We claim:

1. A method for reducing chemical oxygen demand in a water stream comprising:
establishing a protocol for identifying and reducing chemical oxygen demand excursions in the water stream, the protocol including the steps of
generating chlorine dioxide within a mixture including water, sodium chlorite, sodium hypochlorite and an acid;
combining a quantity of the mixture with the water stream sufficient to establish a chlorine dioxide treatment concentration in the water stream; and
oxidizing a portion of the chemical oxygen demand through reaction with the chlorine dioxide during a treatment period to produce a treated water stream.

2. The method for reducing chemical oxygen demand in a water stream according to claim 1, wherein:
sodium chlorite and sodium hypochlorite are used in a mole ratio of 2:1 for generating the chlorine dioxide.

3. The method for reducing chemical oxygen demand in a water stream according to claim 1, wherein:
the acid is selected from a group consisting of hydrochloric acid, sulfuric acid and mixtures thereof.

4. The method for reducing chemical oxygen demand in a water stream according to claim 3, wherein:
the sodium chlorite, sodium hypochlorite and the acid are used in a mole ratio of 2:1:1 to 2:1:2.

5. The method for reducing chemical oxygen demand in a water stream according to claim 1, wherein:
the treatment concentration of chlorine dioxide in the water stream is at least 20 ppm.

6. The method for reducing chemical oxygen demand in a water stream according to claim 5, wherein:
the treatment concentration of chlorine dioxide in the water stream is at least 100 ppm.

7. The method for reducing chemical oxygen demand in a water stream according to claim 5, further comprising:
maintaining the chlorine dioxide treatment concentration in the water stream of at least 50 ppm for a treatment period sufficient to remove at least 50% of the chemical oxygen demand in the water stream.

8. The method for reducing chemical oxygen demand in a water stream according to claim 5, further comprising:
establishing a chlorine dioxide baseline concentration in the water stream, the baseline concentration being no greater than 50% of the treatment concentration.

9. The method for reducing chemical oxygen demand in a water stream according to claim 6, further comprising:
maintaining the chlorine dioxide treatment concentration in the water stream of at least 150 ppm for a treatment period of not more than 1 hour.

10. The method for reducing chemical oxygen demand in a water stream according to claim 1, further comprising:
treating the water stream with a dissolved air flotation process before determining an initial chemical oxygen demand of the water stream.

11. The method for reducing chemical oxygen demand in a water stream according to claim 1, further comprising:
determining an initial chemical oxygen demand of the water stream;
establishing a chlorine dioxide treatment concentration in the water stream; and
subjecting the chlorine-dioxide containing water stream to a dissolved air flotation process.

12. The method for reducing chemical oxygen demand in a water stream according to claim 11, further comprising:
treating the water stream with a flocculant before subjecting the chlorine-dioxide containing water stream to a dissolved air flotation process.

13. The method for reducing chemical oxygen demand in a water stream according to claim 1, further comprising:
measuring an initial chemical oxygen demand of the water stream; and
adjusting the chlorine dioxide treatment concentration in response to variations in the measured initial chemical oxygen demand of the water stream.

14. The method for reducing chemical oxygen demand in a water stream according to claim 1, further comprising:
measuring a post treatment chemical oxygen demand in the treated water stream; and
adjusting the chlorine dioxide treatment concentration in response to variations in the measured post treatment chemical oxygen demand.

15. The method for reducing chemical oxygen demand in a water stream according to claim 13, further comprising:
measuring a post treatment chemical oxygen demand of the treated water stream after the treatment period;
calculating a chemical oxygen demand reduction percentage; and
adjusting the chlorine dioxide treatment concentration to maintain the chemical oxygen demand reduction percentage within a target reduction percentage range.

16. The method for reducing chemical oxygen demand in a water stream according to claim 15, further comprising:
monitoring the water stream for the presence of halogenated disinfection by-products.

17. The method for reducing chemical oxygen demand in a water stream according to claim 16, wherein:
the chemical oxygen demand reduction percentage is maintained in a range between 50% and 75%.

18. The method for reducing chemical oxygen demand in a water stream according to claim 14, further comprising:
adjusting the chlorine dioxide treatment concentration to maintain the chemical oxygen demand within a target post treatment range.

19. The method for reducing chemical oxygen demand in a water stream according to claim 18, wherein:
the target post treatment range is from 0 to 10 ppm.

20. The method for reducing chemical oxygen demand in a water stream according to claim 18, wherein:
the target post treatment range is from 0 to 2 ppm.
